(19) United States
(12) Patent Application Publication
(10) Pub. No.: US 2021/0181389 A1
(43) Pub. Date: Jun. 17, 2021

(54) Retroreflective Marking Embedded with Traditional Marking

(71) Applicants: Christopher R. Sossong, Duxbury, MA (US); Robert Nicholas Murray, Union, ME (US)

(72) Inventors: Christopher R. Sossong, Duxbury, MA (US); Robert Nicholas Murray, Union, ME (US)

(21) Appl. No.: 17/116,548

(22) Filed: Dec. 9, 2020

Related U.S. Application Data
(60) Provisional application No. 62/946,601, filed on Dec. 11, 2019.

(51) Int. Cl. G02B 5/124; B05D 5/06; A41B 1/08; H04N 1/60

(52) U.S. Cl. CPC G02B 5/124; H04N 1/6086; A41B 1/08; B05D 5/063

(57) ABSTRACT

An article having a retroreflective marking and non-retroreflective, traditional marking is provided. The article presents as having a first design when under common overhead or environmental lighting, and having a second different design when the retroreflective marking is illuminated with a direct light, reflecting the light back to its source to cause an illuminated appearance.

### BACKGROUND

### Technical Field

The present disclosure relates generally to paint and ink marking. More particularly the present disclosure relates to an article having both retroreflective and non-retroreflective markings such as ink or paint thereon. The combination allows for a differently appearing article under ambient light compared to direct light such as a flash photograph. Specifically when the retroreflective areas are embedded or masked within the areas that are not light reactive areas of print in such a manner that they are not readily discernible to the naked eye. The method of masking or embedding can include color, texture, patterns, design elements coordinated in such a manner that the retroreflective design will be disguised even to an observer who might be aware of the presence of a hidden retroreflective element. The observer would need a direct light source in order to reveal the embedded retroreflective areas.

### Description of Related Art

In today's digital age, which can be saturated with content, there is a need for bold, eye-catching designs to make a statement and differentiate from other content. These statements need to be brief, attention-grabbing, and memorable so that an impact can be made even when a person is inundated with content from their mobile devices, television, computer screens, and the like.

It has been common place for many years to develop eye catching designs via traditional means, such as bright colors and/or sparkly designs, sequins, and the like. However, these styles are now common and there remains a need for new image and design methodology.

Therefore, what is needed is a marking system for marking an article which provides variable appearances under certain circumstances, for example a shirt having a different appearance under normal sunlight compared to when being flash photographed or otherwise exposed to a direct bright light.

### SUMMARY

The subject matter of this application may involve, in some cases, interrelated products, alternative solutions to a particular problem, and/or a plurality of different uses of a single system or article.

In one aspect, an article is provided which is visible as having a first design marking on its surface when under a first lighting condition, and which presents as a second different design with a partially illuminated appearance under a second direct lighting condition. The article is formed having a surface on which a retroreflective marking and a traditional (non-retroreflective) marking are applied. The retroreflective marking is the same color and/or texture as the traditional marking, or the same color and/or texture as the article. As such, it is not readily apparent that the retroreflective marking is different from the traditional marking, because it is not clearly visibly distinct from the traditional marking or article surface to the naked eye.

In another aspect, a method of recording a digital image of an article having both a retroreflective marking and traditional marking which combine to form a unique and merged design marking the article is provided. The method involves activating a flash mode on a camera. The camera is directed towards the article using the viewfinder and at this point the retroreflective marking is not illuminated as seen through the viewfinder. A digital image is then taken using the camera and flash. This step involves activating the flash causing the retroreflective material to reflect the light from the flash directly to a lens of the camera. This reflection causes the retroreflective material to appear illuminated, forming a second, different design marking the article.

### BRIEF DESCRIPTION OF THE DRAWINGS

FIG. 1 provides a view of an embodiment of the present disclosure on a T-shirt without direct illumination.

FIG. 2 provides a view of an embodiment of the present disclosure on a T-shirt with direct illumination.

FIG. 3 provides a view of an embodiment of the present disclosure on a T-shirt without direct illumination.

FIG. 4 provides a view of an embodiment of the present disclosure on a T-shirt with direct illumination.

FIG. 5 provides a side detail view of an embodiment of the present disclosure.

FIG. 6 provides a side detail view of another embodiment of the present disclosure.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

The present disclosure is directed a photosensitive material printed onto clothing or another article which may be invisible to the naked eye, but visible when directly illuminated, such as by a camera flash. In other words, the reflective portion of the design on the substrate is not readily apparent to the viewer unless a flash, light source or other illumination exposes the retroreflective properties of a portion of the design. Even so, given the retroreflective properties, this illumination is only visible to those close to, or approximately aligned with the origin point of the light source, due to the fact that the retroreflective material directs light back towards the origin point. The clothing or other article contemplated herein has an image printed thereon which is visible with the naked eye, but upon camera flash, an additional image becomes visible. Various embodiments may use standard shirt screen printing techniques or other printing methods. In a particular embodiment, the photosensitive material may be a retroreflective ink or paint.

The concept of this disclosure is to use this retroreflective ink/paint in combination with standard, traditional visible ink/paint/colors/dyes etc. arranged as a first design marking to create a visible image which is then augmented to the eye via a camera/cellphone/other means flash of light. This in turn creates a second, different design marking of the traditional markings, combined with the newly visible markings which relate to the original markings to create a full single concept. This combined traditional and retroreflective markings can be applied across a vast array of media including, but not limited to, clothing, books, playing cards, trading cards, games, magazines, outdoor gear, sports gear, automotive applications, home decor, and hats. Further, this combination of retroreflective marking (ink, paint, powder coating, and the like) in combination with standard, traditional visible markings can also have applications for marketing, signage, and print advertising. This will provide an engaging presentation to present hidden information visible through the flash or other application of light.

Generally, the present disclosure concerns methods and systems for applying traditional markings such as paint and/or ink, among others, to an article, while also applying a supplemental retroreflective material marking to the article. As configured, the article is marked with both the retroreflective material marking, and the traditional paint/ink to form the desired design. Importantly, the retroreflective material will reflect brightly only when a light from a camera flash is directed at it. As such, when flash photographed or otherwise imaged using a flash or similar, the article will have a notably different appearance than when viewed under normal light conditions. The normal light conditions of the marking present as a first design marking, but when viewed under a direct light source such as a flash, the marking presents as a second different design marking. The term direct light is used herein to mean that light is directed, using a flash, lamp, flashlight or other directable light, and is distinguished from standard ambient lighting such as floor lamps, overhead light, sunshine, and the like.

A retroreflective marking material, including paints and inks, is known in the art to be a surface or material which reflects light back toward the light source. Retroreflection uses a surface designed to direct light back toward the source. In many embodiments, retroreflectors have spherical lenses such as tiny glass beads or prismatic elements such as cube corners to reflect the light back towards the light source. Retroreflective materials appear brightest to observers located near the light source (a car's headlights and driver, for example). To observers not close to, or approximately aligned with the light source, no reflection or illumination of the retroreflective material can be seen. Retroreflective materials contemplated herein generally include paints and inks, and in some cases a powder coating, but of course may be any type of material without straying from the scope of this disclosure.

In many embodiments, the retroreflective marking may have the same color as the substrate to which it is applied, and/or the same color as the traditional paint or ink. This allows the retroreflective marking to appear to be the same as the non-retroreflective (traditional) marking material or the article. Thus, the retroreflective marking is not easily distinguished and is “invisible.” An observer does not know that the combined marking can be illuminated until it is illuminated with the flash or other direct light source as viewed by an observer (or camera) close to, or approximately aligned with, the light source. In a particular embodiment, the retroreflective marking may be surrounded by the traditional marking. In another embodiment, the retroreflective material may be on a perimeter of the traditional marking.

As used herein, the term “traditional marking” simply refers to any marking which is not retroreflective, to distinguish from the term “retroreflective material” or “retroreflective marking” which is has retroreflective properties.

In one embodiment, the retroreflective marking material may formed as an ink, paint, or other substrate used for marking having retroreflective beads, prisms, or grains, such as glass beads dispersed therein. The term “retroreflective beads” is used herein to refer to any granular retroreflective material, such as beads, prisms such as cube corners, grains, and the like. In another embodiment, the retroreflective marking material may be formed of multiple layers, for example, retroreflective beads may be dispersed in a clear or translucent substrate, which may be applied in a layer over a colored traditional marking such as ink, paint, and the like or other article surface. In some embodiments, color of the retroreflective marking material may be provided by a pigment. In another embodiment, color of the retroreflective material may be provided by the retroreflective beads (colored glass, for example). In yet another embodiment, color of the retroreflective material may be provided by a colored layer, with retroreflective beads positioned on top of the colored layer. This allows some or all of the traditional marking to be “converted” into a retroreflective marking material.

The substrate article to which the traditional (i.e. non retroreflective) marking, as well as the retroreflective marking material is applied may be any surface capable of receiving the two inks/paints/other materials. In many embodiments, the article is a fabric material such as an article of clothing (shirt, pants, sock, undergarments, outwear, hats, and the like), bags and other personal items, blankets, and other similar fabric items. However, it should be understood that the article is not limited to fabric items, and may also be applied to solid surfaces such as, for example, posters and other wall-hangings, signs, marketing material, electronics cases, and other accessories. Indeed the article may be any material having a surface to which the markings can be applied such as plastics, woods, glass, metals, composites, and the like, among other options, without straying from the scope of this invention.

It should be understood that while typically it is envisioned that the retroreflective marking will be illuminated by a flash from a camera, it may also be illuminated by any direct light, such as a flash light, vehicle headlights, spotlights, and the like. Any viewer close to, or approximately aligned with, the source of the light can then view the illuminated design formed by the traditional and retroreflective markings.

In one embodiment, a method of making a digital photo is provided. The method involves activating a flash on a camera, directing it to the article having retroreflective and traditional markings, and taking the photo with the flash. In this mode, the retroreflective marking will appear illuminated because it reflects the light from the flash directly back at the camera lens. In even further embodiments, the retroreflective marking may appear to have a different color from its surrounding traditional marking when illuminated. This different coloring may be achieved by colored retroreflective beads dispersed in the retroreflective marking, or by a color or pigment within the paint or ink in which the retroreflective material (as disclosed herein) is dispersed. The camera then records the digital image to a digital storage medium such as a memory for storage. The method may further involve taking a contrasting image in which a user turns off the flash and then takes the photo, and in this case the article will appear to have a normal traditional marking on it, without any illumination visible, because the retroreflective material is not reflecting any light directly back to any source.

In one embodiment, a process of making an article, in this case a T-shirt, having the combined retroreflective and traditional markings is provided. This process may have many different iterations, and therefore some non-limiting examples will be provided. In one embodiment, a traditional marking such as screen printing ink may be screen printed on the article. Next, a retroreflective marking may be screen printed on the article. This retroreflective marking may be screen printed directly on the article, and/or may be layered over the traditional marking. In some embodiments, as discussed below, the retroreflective marking may be an ink or paint with retroreflective beads dispersed therein, while the traditional marking may be an ink or paint with non-reflective beads dispersed therein. By including beads in both materials, the same texture, color, and overall appearance is uniform between the two markings, hiding that one is retroreflective. This also allows use of the same printing equipment/nozzles/screens, etc. with both of the two materials.

In another embodiment of making the article, the retroreflective marking material may be applied in a wide area on a surface of the article. The traditional marking may then be applied as a mask over the top of the retroreflective marking material, completing the design. In areas not covered by the mask, the retroreflective bottom layer is exposed and therefore can illuminate when exposed to a direct light such as a camera flash.

In many embodiments, it is important that the retroreflective area of the print cannot be noticed by the naked eye without a direct illumination such as a camera flash. The goal is to make the retroreflective material “invisible,” or as nearly so as possible, until it is intended to be illuminated by direct light and visible to a viewer close to, or approximately aligned with, the direct light source. The present disclosure solves this problem in a number of ways to make the retroreflective marking and traditional marking as integrated and continuous as possible. In one embodiment, the retroreflective marking is formed using a traditional screen printing ink having retroreflective beads or other granular shapes, such as glass beads, mixed therein. In a further embodiment, to match a texture and appearance of the retroreflective bead and ink mixture, the traditional marking is formed of traditional screen printing ink mixed with a bead of similar size which is not retroreflective. As such, the same inks can be used and will achieve an identical or nearly identical texture, color, and overall appearance on the printed substrate, until the retroreflective material is directly illuminated. Using ink containing the glass beads for the retroreflective material/marking, and similarly sized non-reflective beads for the traditional material/marking allows the same screen printing or other equipment to be used to apply both the retroreflective and traditional marking.

In one embodiment, the retroreflective beads can be mixed into a colored or tinted material such as screen printing ink, and the like. In another embodiment, the beads may be mixed with a translucent substrate/ink to act as a carrier for the beads to be applied over an existing traditional marking color.

In other embodiments, the beads may provide retroreflective properties but do not have a visible color. These beads may be applied over a base color, or may be mixed with a colored substrate/ink in order to create the visible color to the naked eye. In another embodiment of retroreflective bead, the bead itself has a color which is apparent to the naked eye. In this case the beads may be mixed and applied using a clear substrate/ink as a carrier, allowing the color of the beads to create the visible color to the naked eye. In both cases the appearance of the beads is dramatically different when viewed with flash, light source or other means of exposing the retroreflective properties.

In another embodiment, multiple layers of ink or other marking may be applied to the substrate. For example, in one embodiment, a large area of retroreflective marking may be applied to the substrate. A second layer or “mask” of traditional marking material may be applied over some, but not all of the retroreflective marking. This causes the retroreflective effect to only be over a portion of the total marking area, because it is partially covered by the mask. In other embodiments, the mask may be a thin colored, transparent, or translucent layer which is different from traditional marking materials, such as a film, plastic sheeting, and the like. The mask may be any material which can be applied to the retroreflective marking so as to block the retroreflection on areas the mask covers. Typically, the mask is formed of a traditional screen print, paint, or similar application without retroreflective properties.

In some embodiments, the mask layer or layers will seek to be an exact match in color and/or texture with the retroreflective marking to “hide” the retroreflective portions when viewed with the naked eye and until directly illuminated. In other embodiments, the mask may be a different color and/or texture from the retroreflective portion, to maintain continuity of design presented on the article (T-shirt designs, and others as disclosed herein). In still further embodiments, the mask itself may have varying colors and/or textures, as dictated by the desired appearance of the printed design.

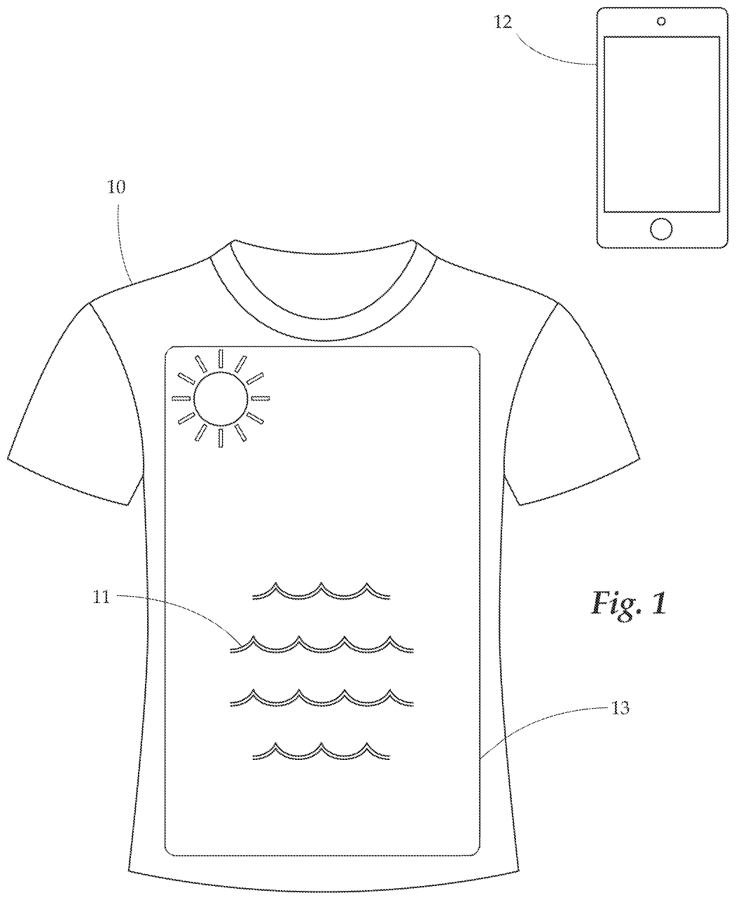

Turning now to FIG. 1, an embodiment of the present disclosure applied to a T-shirt article is shown. The T-shirt article 10 has a print area 13 which, in this embodiment, appears as a traditional T-shirt design having a traditional marking area 11. A camera 12, shown here as the camera on a mobile phone, has a flash setting set to off. As such, upon capturing an image of the T-shirt 10, it appears as a traditional t-shirt with a traditional marking print area 11.

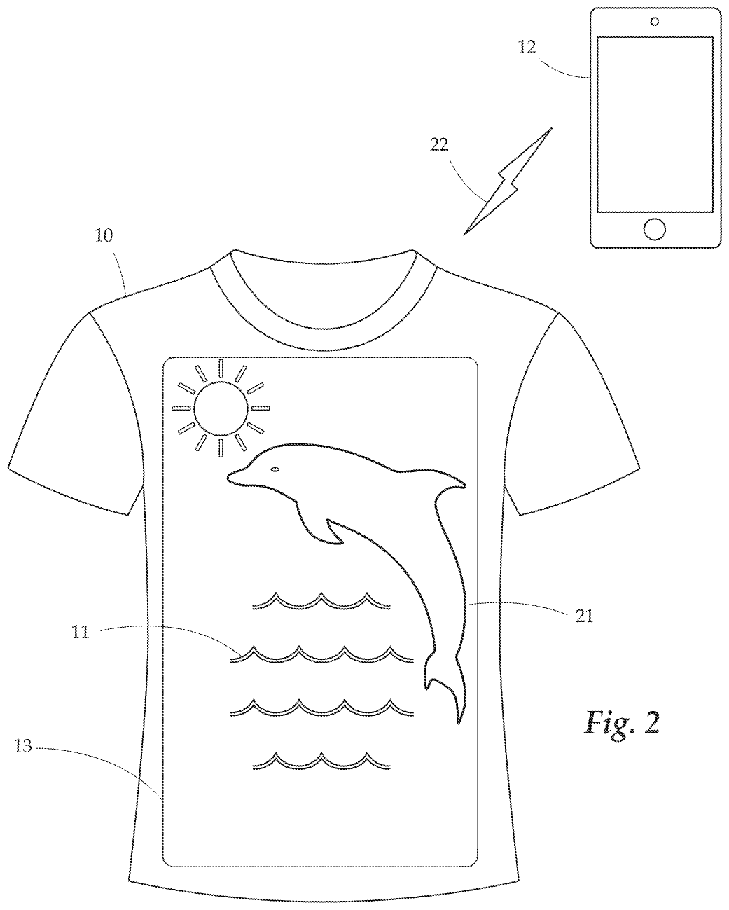

FIG. 2 shows an embodiment of the same T-shirt of FIG. 1 but this time, directly illuminated by a flash 22 of a camera 12. Here, the retroreflective marking material 21 of the print area 13 is exposed by the light of flash 22 directed at the retroreflective marking material 21. The light from flash 22 is directed right back to its source, which is the camera 12. The camera 12 in turn, can record an image showing the T-shirt article 10 as well as both the traditional marking area 11 and retroreflective marking material 21.

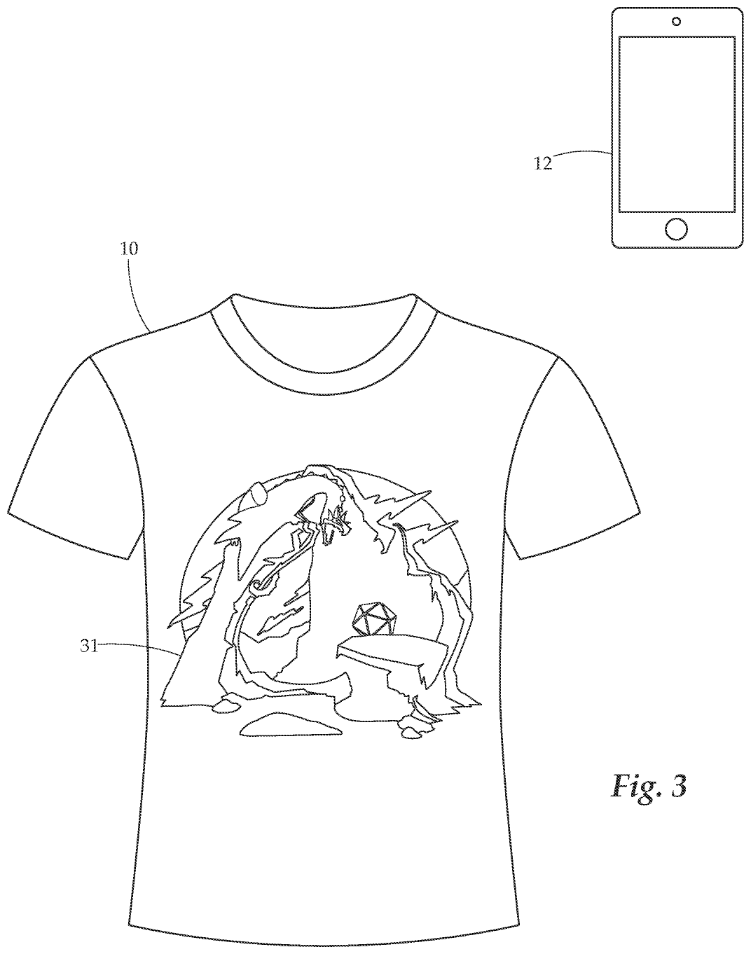

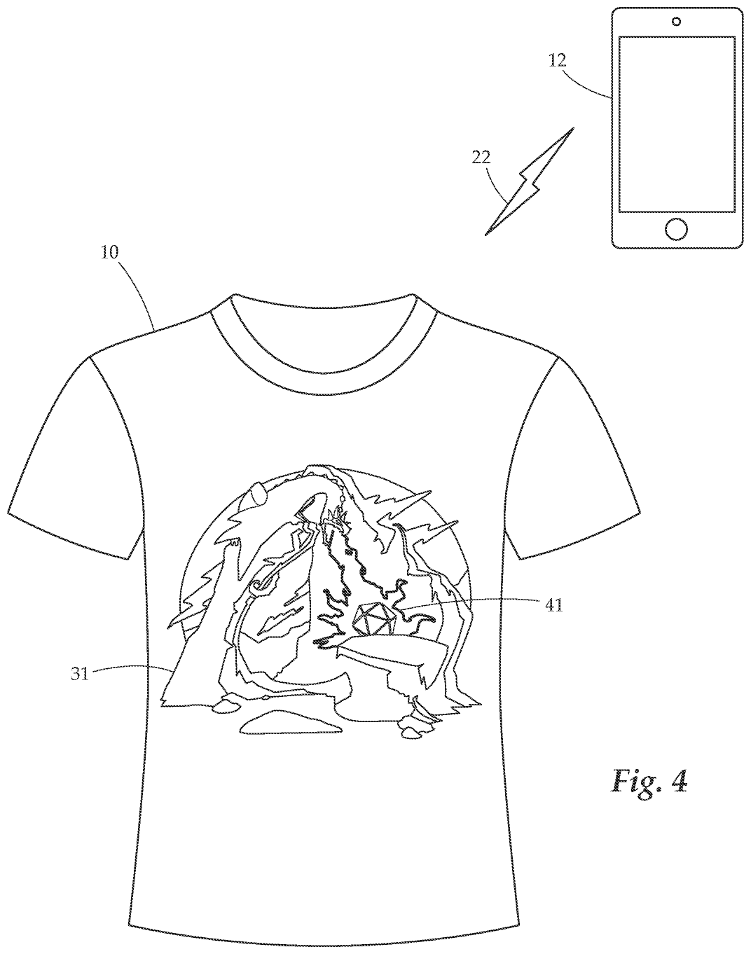

FIGS. 3 and 4 provide similar contrasting views of a T-shirt article as viewed under ambient light conditions and direct lighting conditions near a source of the direct light. In this view, the traditional marking 11 is visible in FIG. 3, and appears as a traditional shirt, with the retroreflective marking not visible. Instead, the retroreflective marking appears to be part of the traditional marking, and is not discernable from the remainder of the design. However, in FIG. 4 shows the article 10 being photographed and recorded by a camera 12 using a flash 22. The flash 22 illuminates the retroreflective marking material 21 which can then be captured in an image by the camera 12. Of course, other sources of direct illumination other than a flash 22 are possible, such as a flashlight, vehicle light, stage lighting, spotlights, and the like without straying from the scope of this invention.

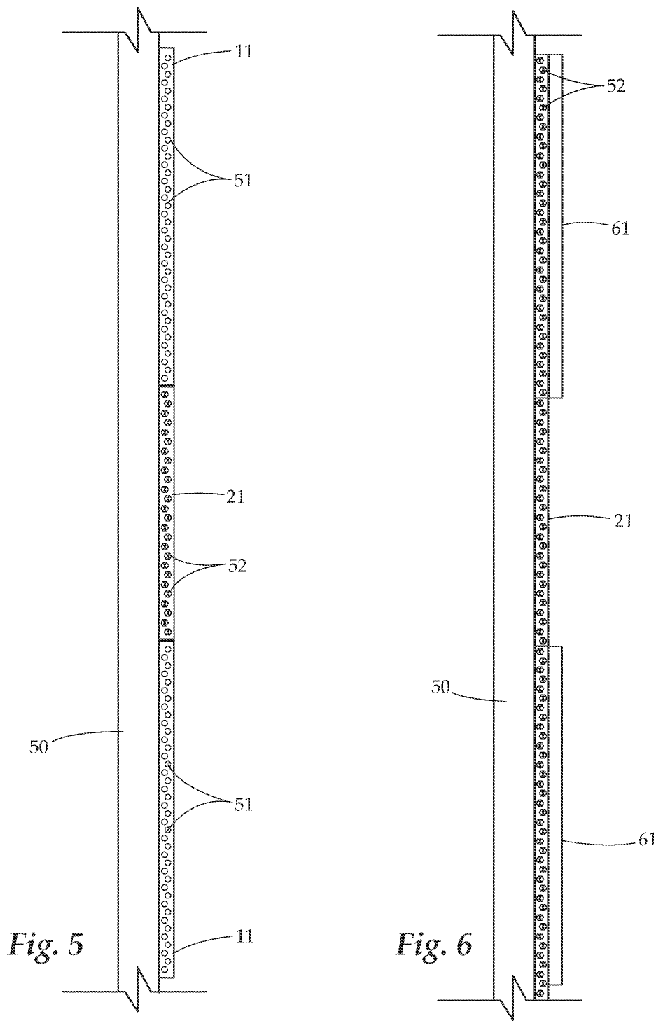

FIG. 5 provides a side cutaway detail view of an embodiment of the traditional marking and retroreflective marking on a substrate. In this view, both the traditional marking 11 and retroreflective marking 21 are applied in a layer directly on substrate 50. The layers are approximately the same thickness and texture, causing the two to appear the same without direct light applied. As will be understood to those skilled in the art, in practice, the distinction between layers will not be as clear as that shown in FIGS. 5 and 6. There will inevitably be some variance in layers, overlap, and possibly intermixing of the layers. These figures are merely illustrative.

The traditional marking has beads 51 dispersed therein. These beads 51 are non-reflective, but provide a textured appearance and “body.” Similarly, retroreflective marking 21 has retroreflective glass beads 52 dispersed therein. These beads 52 provide the retroreflective properties to the retroreflective marking 21. In this embodiment, beads 51 and 52 are both approximately the same size and are dispersed in approximately the same density as each other. This provides continuity in texture and appearance between the traditional marking 11 and retroreflective marking 21, which helps to make the two indistinguishable until the retroreflective marking is directly illuminated and viewed by one close to, or approximately aligned with, the light source. In this embodiment, the retroreflective marking and traditional marking have approximately the same thickness such that they have an approximately parallel surface with each other.

The combination of retroreflective beads 52 and retroreflective marking 21 may vary depending on embodiment, and may also be used in combination with traditional marking paint or ink to create varied appearances. For example, the ink or paint in one embodiment may be transparent to allow for a maximum retroreflection. In another embodiment, the ink or paint may be translucent and/or colored, to cause the retroreflected light to also take on some of this color, thereby creating a unique and desirable presentation when illuminated. Similarly, colored retroreflective beads may be used to also control a color of the reflected light. These colored beads may be in a transparent or translucent material. In other embodiments, the colored beads may be dispersed in a colored ink or paint which is a different color from the beads. This can cause a very interesting reflective effect having a first non-illuminated color, and a second, different illuminated color. In other embodiments, the paint or ink may be opaque or nearly opaque, to control an amount, color, and intensity of retroreflection. In still further embodiments, a retroreflective material comprised of clear ink or paint having retroreflective beads dispersed therein can be layered over a different colored traditional ink or paint to create colored and reflective effects. Retroreflective and traditional markings can be of varying thicknesses, including tapering thicknesses over one another to create transition appearances. The retroreflective and traditional markings can be blended as well to create more or less retroreflective materials, to create smooth transitions as needed, and for other design features.

FIG. 6 provides another side cutaway detail view of an embodiment of the traditional marking and retroreflective marking on a substrate. In this embodiment, the retroreflective marking material 21 is applied directly to a surface of the substrate 50, though direct application to the substrate surface is not necessarily required. The retroreflective marking material 21 comprises retroreflective beads 52 dispersed therein, which provide the retroreflective properties to the retroreflective marking 21. On top of a portion of the retroreflective marking material 21 is a mask 61 of, among other options, traditional marking material such as screen printing ink, paint, and the like, or a film layer which blocks the retroreflection of areas that it covers. A portion of the retroreflective marking material 21 remains exposed. In such an embodiment, the retroreflective marking material can appear illuminated to those viewing it close to, or approximately aligned with, the light source illuminating it only at areas not covered by the mask 61.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A method of recording a digital image of an article having both a retroreflective marking and traditional markings, comprising the steps of:
activating a flash mode on a camera;
directing the camera towards the article using a viewfinder, wherein the retroreflective marking material is not illuminated as seen on the viewfinder, such that the article appears as having a first design marking;
taking a digital image, the step of taking the image comprising activating the flash, the retroreflective marking material reflecting the light from the flash directly to a lens of the camera, causing the retroreflective marking material to appear illuminated, forming a second, different design marking of the article.

2. The method of claim 1 wherein the retroreflective marking is of a same color as the traditional marking.

3. The method of claim 1 wherein the retroreflective marking is of a same color as the article.

4. The method of claim 1 wherein the step of taking the digital image comprises recording the digital image to a digital storage medium.

5. The method of claim 1 wherein the retroreflective marking is surrounded by the traditional marking.

6. The method of claim 1 further comprising the step of exposing the article to a second general light source providing illumination to the article, the second general light source being one of sunlight and a room lighting.

7. The method of claim 1 wherein the step of taking the digital image comprises directing the flash directly at the retroreflective marking.

8. The method of claim 1 wherein the retroreflective marking and traditional marking are paint or ink.

9. An article operable to present as a first design marking on its surface when under a first lighting condition, and to display a second different design marking on its surface when under a second direct lighting condition, the article comprising:
a surface having a retroreflective marking and a traditional marking thereon forming the first design, wherein the retroreflective marking is a same color as the traditional marking or a same color as the article.

10. The article of claim 9 wherein the article is a clothing article.

11. The article of claim 9 wherein the traditional marking surrounds the retroreflective marking.

12. The article of claim 9 wherein the retroreflective marking is on a perimeter of the traditional marking.

13. The article of claim 9 wherein the retroreflective marking and traditional marking are a paint or ink which extends above the surface of the article, wherein the retroreflective marking and traditional marking extend a same distance above the surface so that they have an approximately parallel surface with each other.

14. The article of claim 9 wherein the retroreflective marking comprises a plurality of glass beads dispersed within a screen printing paint or ink.

15. The article of claim 9 wherein the retroreflective marking comprises a plurality of colored glass beads dispersed in a translucent or transparent retroreflective paint or ink.

16. The article of claim 14 wherein the screen printing ink is transparent, and wherein the retroreflective marking is applied over a layer of traditional marking.

17. The article of claim 14 wherein the traditional marking comprises a plurality of non-reflective beads dispersed within a second screen printing ink.

18. The article of claim 17 wherein the plurality of non-reflective beads are of approximately the same size as the plurality of glass beads.

19. The article of claim 9 wherein the surface comprises a first layer of retroreflective marking, and a second mask layer covering only a part of the first retroreflective marking layer.

20. The article of claim 9 wherein at least a part of the second mask layer has a same color as the retroreflective marking.
